(19) United States
(12) Patent Application Publication
(10) Pub. No.: US 2024/0235110 A9
(43) Pub. Date: Jul. 11, 2024

(54) CABLE CONNECTOR

(71) Applicant: HIROSE ELECTRIC CO., LTD., Kanagawa (JP)

(72) Inventor: Hiroshi KAWASHIMA, Kanagawa (JP)

(21) Appl. No.: 18/486,773

(22) Filed: Oct. 13, 2023

(30) Foreign Application Priority Data
Oct. 21, 2022 (JP) 2022-169297

(51) Int. Cl. H01R 13/625

(52) U.S. Cl. CPC H01R 13/625

(57) ABSTRACT

A cable connector includes a terminal, a housing, and a shell. The shell has: a lock portion having an engagement portion that, upon the cable connector mating with a counterpart connector, is engaged with a protruding portion or a recessed portion formed on an outer side surface of the counterpart connector and locks the counterpart connector; a housing holding portion; and a cable holding portion. The shell further has: a first slit formed on a second side opposite in the axial direction to a first side that mates with the counterpart connector, the first slit extending along a circumferential direction of the shell; two second slits extending respectively from two end portions of the first slit toward the second side; and a third slit extending along the axial direction from an end portion on the first side of the shell to the first slit.

### CROSS-REFERENCE TO RELATED APPLICATION

This application claims priority from Japanese Patent Application No. 2022-169297 filed with the Japan Patent Office on Oct. 21, 2022, the entire content of which is hereby incorporated by reference.

### BACKGROUND

### 1. Technical Field

One aspect of the present disclosure relates to a cable connector.

### 2. Related Art

A cable connector is conventionally used which includes a terminal that is connected to an electric wire (conducting wire) in a cable, a housing (or equivalently, an insulated case) that holds the terminal, and a shell (typically made of metal) that is formed in such a manner as to cover the housing. For example, in a multi-contact connector (cable connector) described in JP-A-2006-66354, a connector mating portion of the connector mates with a counterpart connector mating portion of a counterpart connector. Consequently, a contact terminal of the connector comes into contact with a contact terminal of the counterpart connector to allow a locking means provided to an outer peripheral portion of the shell to couple the connector to the counterpart connector.

### SUMMARY

A cable connector which includes: a terminal that is connected to an electric wire in a cable; a housing that holds the terminal; and a shell having an approximately cylindrical shape, the shell being formed in such a manner as to cover the housing and to receive a counterpart connector that mates with the cable connector, in which the shell includes: a lock portion having an engagement portion that, upon the cable connector being mated to the counterpart connector, is engaged with a protruding portion or a recessed portion formed on an outer side surface of the counterpart connector and locks the counterpart connector; a housing holding portion that holds the housing; and a cable holding portion that holds the cable, the lock portion, the housing holding portion, and the cable holding portion of the shell are integrally formed along an axial direction of the shell, and the shell further includes: a first slit formed on a second side opposite in the axial direction to a first side that mates with the counterpart connector relative to the engagement portion of the lock portion, the first slit extending along a circumferential direction of the shell; two second slits extending respectively from two end portions of the first slit toward the second side; and a third slit extending along the axial direction from an end portion on the first side of the shell to the first slit.

### BRIEF DESCRIPTION OF DRAWINGS

FIG. 1 is a perspective view illustrating a state before a cable connector according to an embodiment of the present disclosure mates with a counterpart connector;

FIG. 2 is a perspective view illustrating a state of the cable connector according to the embodiment of the present disclosure and the counterpart connector being mated together;

FIG. 3 is a cross-sectional view of the cable connector according to the embodiment of the present disclosure and the counterpart connector as viewed along line III-III of FIG. 2;

FIG. 4 is an exploded perspective view of the cable connector according to the embodiment of the present disclosure;

FIG. 5 is an enlarged perspective view of a shell and a housing of the cable connector according to the embodiment of the present disclosure as viewed from the front;

FIG. 6 is a perspective view of the shell of the cable connector according to the embodiment of the present disclosure;

FIG. 7 is a perspective view of the shell of the cable connector according to the embodiment of the present disclosure as viewed from an opposite side to FIG. 6 (from below);

FIG. 8 is a cross-sectional view of the shell and the housing of the cable connector according to the embodiment of the present disclosure as viewed along line VIII-VIII of FIG. 5;

FIG. 9 is an explanatory diagram of the behavior of the shell at the time of mating of the cable connector according to the embodiment of the present disclosure and the counterpart connector;

FIG. 10 is an explanatory diagram of the behavior of the shell at the time of unlocking the cable connector according to the embodiment of the present disclosure and the counterpart connector; and

FIG. 11 is a perspective view of a shell of a cable connector according to a modification of the embodiment of the present disclosure.

### DETAILED DESCRIPTION

In the above cable connector described in JP-A-2006-66354, a cylindrical rotatable sleeve is provided outside the shell, and the sleeve is provided with a lock portion. The lock portion is engaged in a lock groove portion of a counterpart connector. However, if such a configuration in which the sleeve is provided further outside the shell is adopted, the size of the entire cable connector tends to be increased.

One object of the present disclosure is to reduce the size of an entire cable connector that is configured in such a manner as to lock a counterpart connector at the time of mating with the counterpart connector.

A cable connector according to an embodiment of the present disclosure includes: a terminal that is connected to an electric wire in a cable; a housing that holds the terminal; and a shell having an approximately cylindrical shape, the shell being formed in such a manner as to cover the housing and to receive a counterpart connector that mates with the cable connector, in which the shell includes: a lock portion having an engagement portion that, upon the cable connector being mated to the counterpart connector, is engaged with a protruding portion or a recessed portion formed on an outer side surface of the counterpart connector and locks the counterpart connector; a housing holding portion that holds the housing; and a cable holding portion that holds the cable, the lock portion, the housing holding portion, and the cable holding portion of the shell are integrally formed along an axial direction of the shell, and the shell further includes: a first slit formed on a second side opposite in the axial direction to a first side that mates with the counterpart connector relative to the engagement portion of the lock portion, the first slit extending along a circumferential direction of the shell; two second slits extending respectively from two end portions of the first slit toward the second side; and a third slit extending along the axial direction from an end portion on the first side of the shell to the first slit.

According to the above embodiment of the present disclosure, it is possible to reduce the size of the entire cable connector that is configured in such a manner as to lock the counterpart connector at the time of mating with the counterpart connector.

Embodiments of the present disclosure are described hereinafter with reference to the drawings. Note that the same reference numerals are assigned to the same members in principle in all the drawings for describing the embodiments, and repeated descriptions thereof are omitted. Moreover, the embodiments (including a modification) are described independently. However, a configuration of the cable connector based on combinations of components of the embodiments should not be excluded.

Configuration of Cable Connector

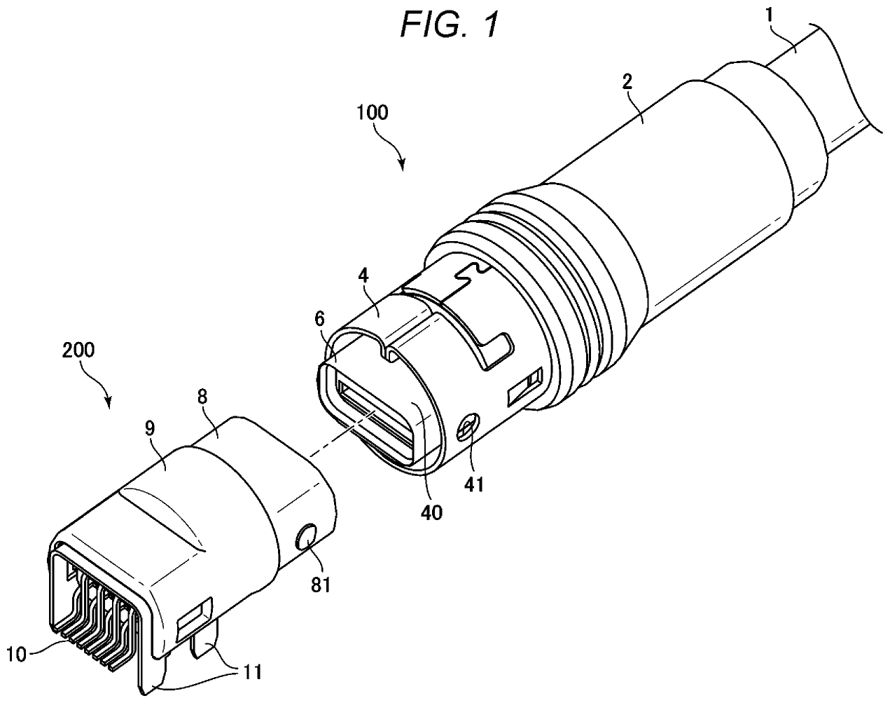

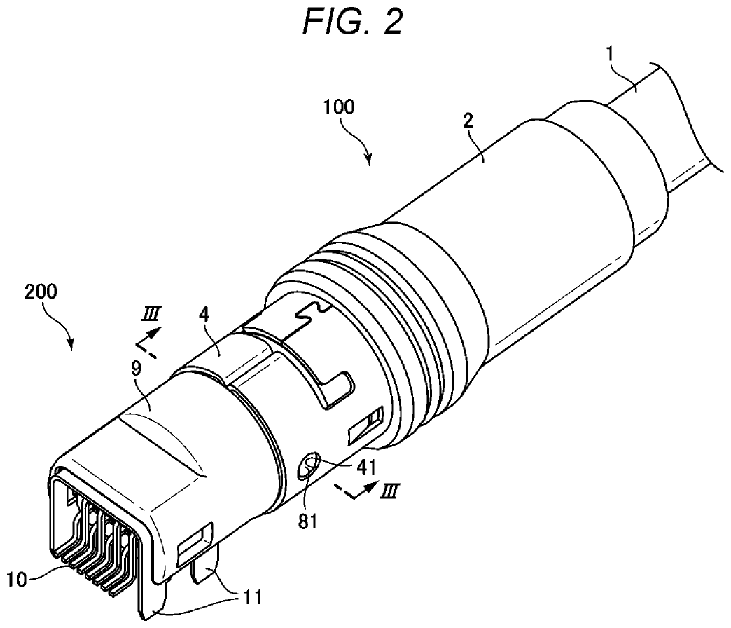

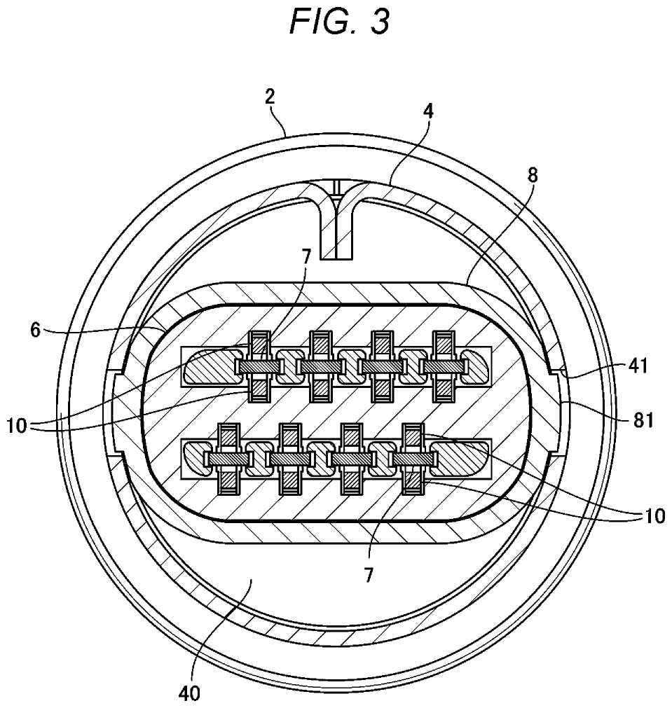

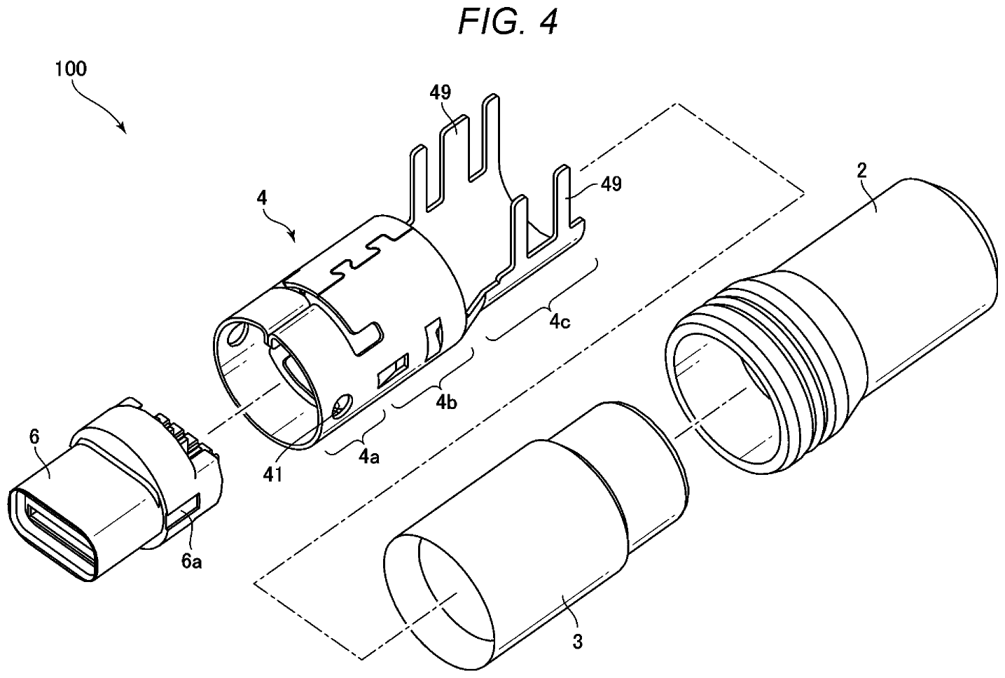

Firstly, the entire configuration of a cable connector according to the embodiment is described with reference to FIGS. 1 to 4. FIG. 1 is a perspective view illustrating a state before the cable connector according to the embodiment mates with a counterpart connector that mates with the cable connector. FIG. 2 is a perspective view illustrating a state of the cable connector according to the embodiment and the counterpart connector being mated together. FIG. 3 is a cross-sectional view of the cable connector according to the embodiment and the counterpart connector as viewed along line III-III of FIG. 2. FIG. 4 is an exploded perspective view of the cable connector according to the embodiment.

As illustrated in FIG. 1, a cable connector 100 is what is called a circular connector having an approximately cylindrical shape. The cable connector 100 is configured in such a manner as to be mounted on a cable 1 including a plurality of electric wires (conducting wires or an inner conductor) and to mate with a counterpart connector 200. Specifically, the cable connector 100 includes an insulated case 2 that forms an outermost shell of the cable connector 100, a shell 4, and an insulated housing 6. The shell 4 is provided to the case 2 on a side that mates with the counterpart connector 200 in an axial direction, has an approximately cylindrical shape, and forms a mating space 40 that receives the counterpart connector 200. The housing 6 holds terminals 7 (refer to FIG. 3) that are connected to the electric wires in the cable 1, and is provided in the shell 4. In other words, the shell 4 has an approximately cylindrical shape, and is formed in such a manner as to cover the housing 6 and to receive the counterpart connector 200 that mates with the cable connector 100. The shell 4 is made of metal, and is used for noise suppression (shield). Such a cable connector 100 is applied to an apparatus or device that requires a small connector such as a small sensor or a robot arm.

Note that hereafter, a side, which mates with the counterpart connector 200 in the axial direction (corresponding to a first side), of the cable connector 100 is simply referred to as the “front side,” and the opposite side (corresponding to a second side) is simply referred to as the “back side.”

On the other hand, as illustrated in FIG. 1, the counterpart connector 200 is configured as a board-type connector that is connected to a board (not illustrated). Specifically, the counterpart connector 200 includes a housing (not illustrated) that holds terminals 10, a mating portion 8, a metal shell 9, a plurality of the terminals 10, and a fixing portion 11 for fixing the counterpart connector 200 to the board (not illustrated). The mating portion 8 is a portion that is received in the mating space 40 of the shell 4 of the cable connector 100. The shell 9 forms an outermost shell of the counterpart connector 200. Note that the counterpart connector may be various connectors other than a board-type connector, for example, a cable-type connector.

When the cable connector 100 and the counterpart connector 200 are mated together, the mating portion 8 of the counterpart connector 200 enters the mating space 40 formed by the shell 4 of the cable connector 100 as illustrated in FIGS. 2 and 3. At this point in time, two protruding portions 81 formed on outer side surfaces of the mating portion 8 of the counterpart connector 200 are engaged in two through-holes 41 formed in the shell 4 of the cable connector 100, respectively (refer to FIG. 3). Consequently, the counterpart connector 200 is locked (or equivalently, fastened) by the cable connector 100. The two through-holes 41 are provided in the shell 4 in such a manner as to face each other in a direction orthogonal to the axial direction. The two protruding portions 81 are provided on the mating portion 8 in such a manner as to face each other in the direction orthogonal to the axial direction.

More specifically, when the cable connector 100 and the counterpart connector 200 are mated together, the mating portion 8 of the counterpart connector 200 fits onto the housing 6 of the cable connector 100 without any gaps as illustrated in FIG. 3. In addition, at the time of such mating, each of a plurality of the flat-shaped terminals 7 of the cable connector 100 is inserted into a gap formed by its respective pair of the plurality of the terminals 10 of the counterpart connector 200, and comes into contact with the terminals 10. Consequently, the cable connector 100 and the counterpart connector 200 are electrically connected together.

Note that the through-holes 41 of the cable connector 100 are an example of “engagement portions” in the embodiment. In other words, at the time of mating of the cable connector 100 and the counterpart connector 200, the through-holes 41 are engaged with protruding or recessed portions formed on the outer side surfaces of the counterpart connector 200 to lock the counterpart connector 200. In another example, recessed portions that are engaged with the protruding portions 81 of the counterpart connector 200 may be used as such engagement portions instead of the through-holes 41. In still another example, if recessed portions or through-holes are formed instead of the protruding portions 81 in the counterpart connector 200, protruding portions that are engaged in the recessed portions or through-holes may be used as the engagement portions of the cable connector 100.

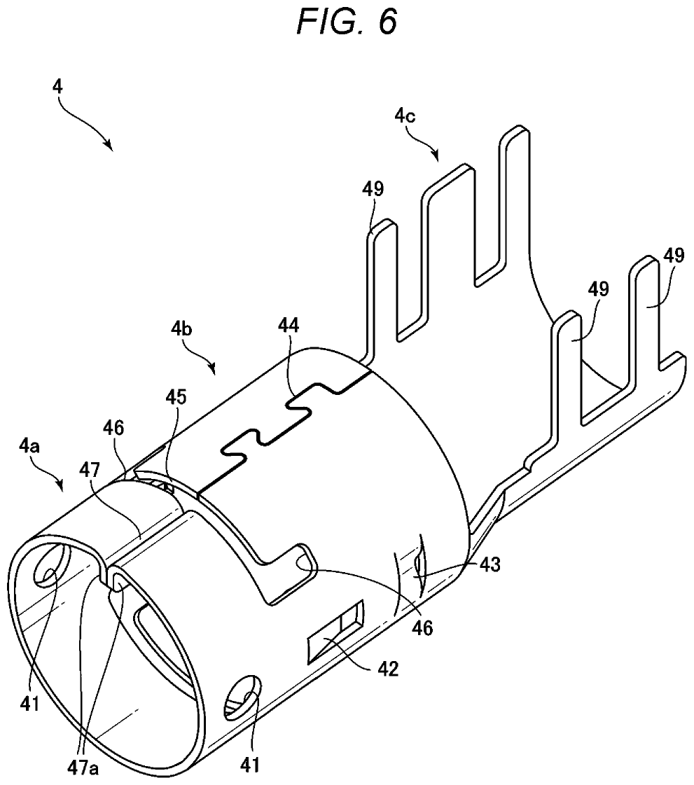

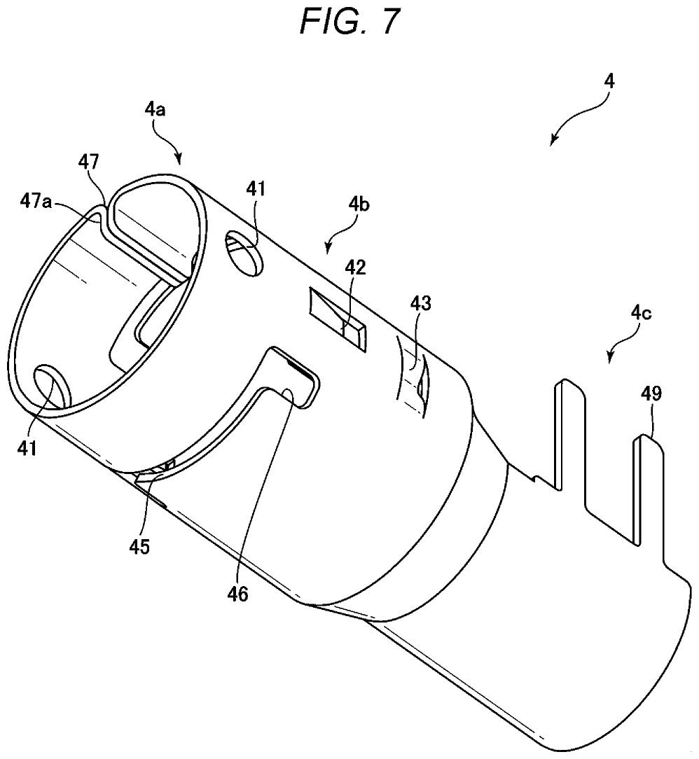

Next, as illustrated in FIG. 4, the shell 4 of the cable connector 100 includes a lock portion 4a having the above through-holes 41 for locking the counterpart connector 200, a housing holding portion 4b for holding the housing 6, and a cable holding portion 4c for holding the cable 1 (not illustrated). Furthermore, in the shell 4, the lock portion 4a, the housing holding portion 4b, and the cable holding portion 4c are integrally formed along the axial direction of the shell 4. The cable holding portion 4c of the shell 4 is configured in such a manner as to hold the cable 1 by bending a plurality of crimp pieces 49 and crimping the cable 1 (FIG. 4 illustrates the shell 4 before the crimp pieces 49 are crimped. The same applies to FIGS. 6 and 7 below). In this case, more specifically, the cable 1 of which an outer conductor inside has been exposed and put on the outer side is crimped with the crimp pieces 49 of the cable holding portion 4c. A heat-shrink tube 3 is mounted on the outer side of the cable holding portion 4c that is crimping the cable 1. The case 2 is put further outside the heat-shrink tube 3. On the other hand, the plurality of electric wires is exposed at a distal end portion of the cable 1. The plurality of electric wires is soldered to the terminals 7 (not illustrated in FIG. 4) exposed at the back of the housing 6.

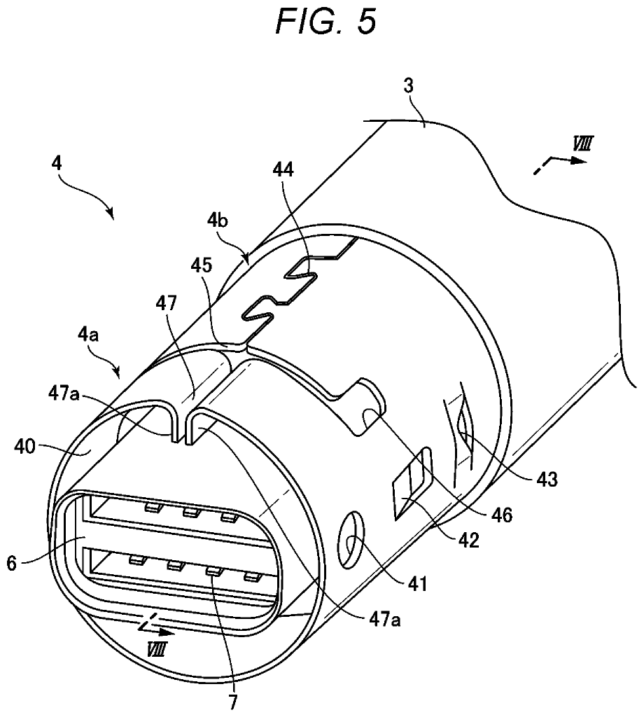

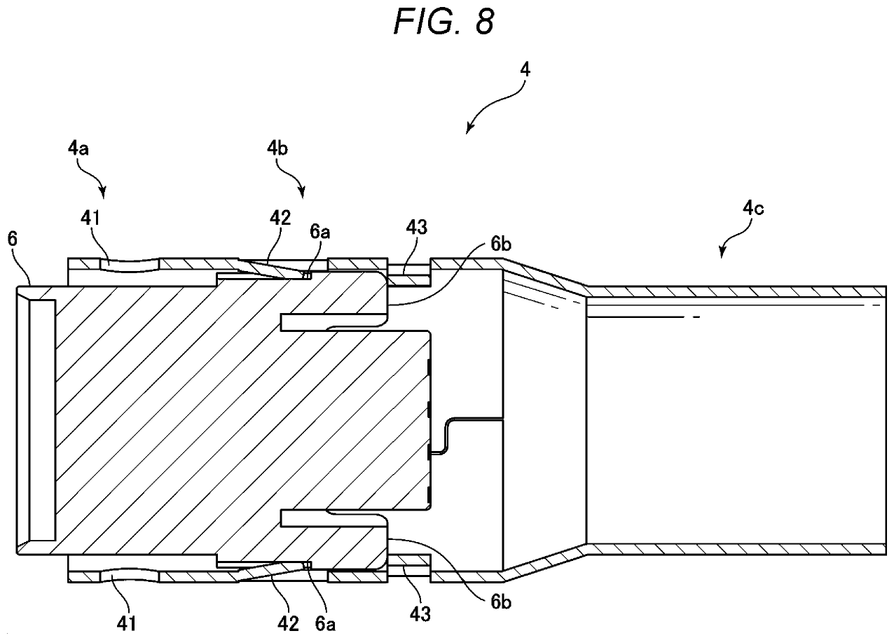

Next, the shell 4 of the cable connector 100 according to the embodiment is specifically described with reference to FIGS. 5 to 8. FIG. 5 is an enlarged perspective view of the shell 4 and the housing 6 of the cable connector 100 according to the embodiment as viewed from the front. FIG. 6 is a perspective view of the shell 4 of the cable connector 100 according to the embodiment. FIG. 7 is a perspective view of the shell 4 of the cable connector 100 according to the embodiment as viewed from an opposite side to the perspective view of FIG. 6 (assuming that FIG. 6 is a perspective view of the shell 4 as viewed from above, FIG. 7 is a perspective view of the shell 4 as viewed from below). FIG. 8 is a cross-sectional view of the shell 4 and the housing 6 of the cable connector 100 according to the embodiment as viewed along line VIII-VIII of FIG. 5.

As illustrated in FIGS. 5 to 7, the shell 4 of the cable connector 100 includes a first slit 45 that is formed backward of the through-holes 41 of the lock portion 4a and extends along a circumferential direction of the shell 4, two second slits 46 that extend backward from two end portions of the first slit 45, and a third slit 47 that extends along the axial direction from a front end portion of the shell 4 to the first slit 45. Specifically, the two second slits 46 extend along the axial direction respectively from the two end portions of the first slit 45 in such a manner as to be orthogonal to the first slit 45. Moreover, the third slit 47 is coupled to a substantially central portion of the first slit 45 in the circumferential direction. Furthermore, as can be seen from FIGS. 6 and 7, the shell 4 includes a pair of the first slits 45, and a pair of the two second slits 46. The pair of the first slits 45 is provided in such a manner as to face each other in a direction orthogonal to the axial direction, and the pair of the two second slits 46 is provided in such a manner as to face each other in the direction orthogonal to the axial direction.

Note that the formation of the second slits 46 is not limited to being formed in such a manner as to be orthogonal to the first slit 45. In other words, the intersection angle of the second slit 46 with respect to the first slit 45 is not limited to a setting of 90 degrees. In another example, the intersection angle of the second slit 46 with respect to the first slit 45 may be set at an angle less or greater than 90 degrees.

Moreover, as can be seen from FIGS. 5 and 6, the shell 4 is produced by curving a plate-shaped member (metal plate) in such a manner as to form an approximately cylindrical shape. In this case, a portion at each of two ends of the plate-shaped member, or more specifically portions excluding the first slit 45, the third slit 47, and the cable holding portion 4c, are joined together (refer to a joint 44) to form the approximately cylindrical shell 4. Moreover, in the curved plate-shaped member, the other portions at the two ends, or more specifically portions 47a located forward of the above joint 44, are in a gently bent state. In other words, the shell 4 is produced by curving the plate-shaped member of which portions (the bent portions 47a) at the two ends have been bent, in such a manner as to form an approximately cylindrical shape. Such bent portions 47a at the two ends of the plate-shaped member are not joined together. Hence, there is a gap between the bent portions 47a, and the gap forms the above third slit 47.

Next, as illustrated in FIG. 8, the shell 4 includes, in the housing holding portion 4b, claw-like first holding portions 42 that are bent inward, and second holding portions 43 that are provided backward of the first holding portions 42 and depressed inward. Specifically, the first holding portions 42 are formed in such a manner as to be inclined inward toward the back side. Moreover, the shell 4 includes a pair of such first holding portions 42 and a pair of such second holding portions 43. The pair of the first holding portions 42 is provided in such a manner as to face each other in the direction orthogonal to the axial direction, and the pair of the second holding portions 43 is provided in such a manner as to face each other in the direction orthogonal to the axial direction.

The housing 6 is inserted into the shell 4 from the front side. At this point in time, the first holding portions 42 of the shell 4 are engaged in depressed portions 6a (refer also to FIG. 4) formed in an outer peripheral surface of the housing 6 in such a manner as to be depressed, and the second holding portions 43 of the shell 4 come into contact with a bottom wall 6b of the housing 6. In this manner, the first holding portions 42 of the shell 4 are engaged in the depressed portions 6a of the housing 6 to restrict the forward movement of the housing 6. Furthermore, the second holding portions 43 of the shell 4 come into contact with the bottom wall 6b of the housing 6 to restrict the backward movement of the housing 6. As a result, the housing 6 is held by the housing holding portion 4b of the shell 4.

Operations and Effects

Next, the operations and effects of the cable connector 100 according to the above-mentioned embodiment are described.

The cable connector 100 according to the embodiment includes the terminals 7 that are connected to the electric wires in the cable 1, the housing 6 that holds the terminals 7, and the shell 4 that has an approximately cylindrical shape and is formed in such a manner as to cover the housing 6 and to receive the counterpart connector 200 that mates with the cable connector 100. The shell 4 includes the lock portion 4a having the through-holes 41 that, at the time of mating of the cable connector 100 and the counterpart connector 200, are engaged with the protruding portions 81 formed on the outer side surfaces of the counterpart connector 200 and lock the counterpart connector 200, the housing holding portion 4b that holds the housing 6, and the cable holding portion 4c that holds the cable 1. The lock portion 4a, the housing holding portion 4b, and the cable holding portion 4c are integrally formed along the axial direction. The shell 4 further includes the first slit 45 that is formed backward of the through-holes 41 of the lock portion 4a and extends along the circumferential direction, the two second slits 46 that extend backward respectively from the two end portions of the first slit 45 and the third slit 47 that extends along the axial direction from the front end portion of the shell 4 to the first slit 45.

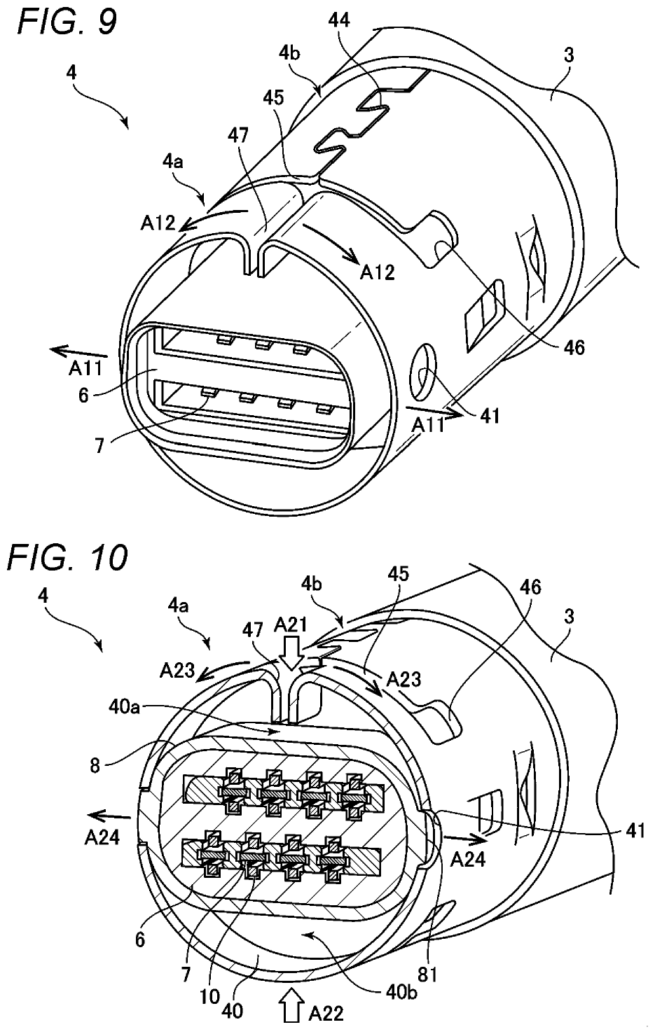

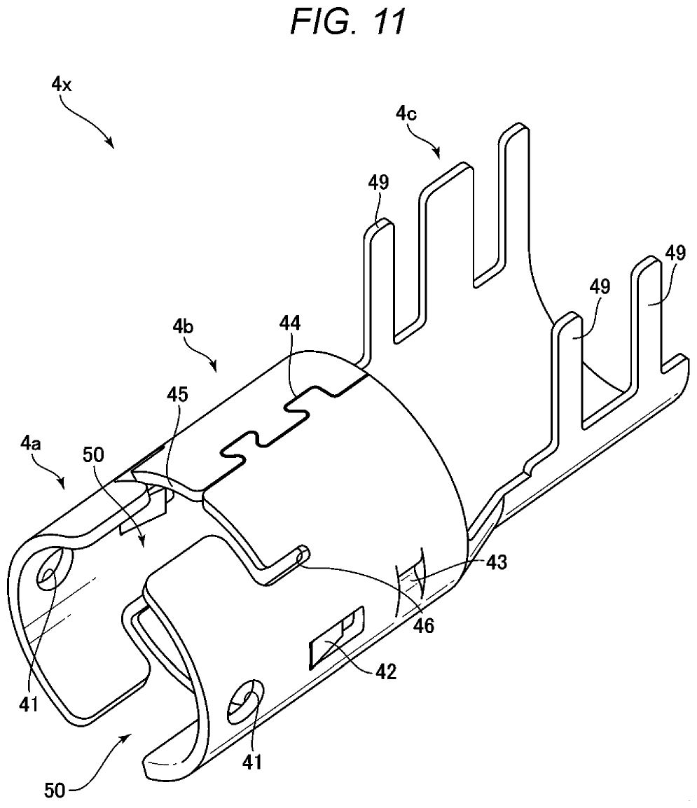

The operations and effects of such a cable connector 100 are described with reference to FIGS. 9 and 10. FIG. 9 is a perspective view of the shell 4 and the housing 6 of the cable connector 100 according to the embodiment, which is similar to FIG. 5. FIG. 9 is particularly an explanatory diagram of the behavior of the shell 4 at the time of the mating of the cable connector 100 and the counterpart connector 200, or more specifically at the time of locking the counterpart connector 200 with the cable connector 100. FIG. 10 is a cross-sectional perspective view of the shell 4 and the housing 6 of the cable connector 100 according to the embodiment and the mating portion 8 of the counterpart connector 200 as viewed along line III-III of FIG. 2. FIG. 10 is particularly an explanatory diagram of the behavior of the shell 4 at the time of unlocking the cable connector 100 and the counterpart connector 200.

Firstly, the mating of the cable connector 100 and the counterpart connector 200 is described with reference to FIG. 9. At the time of the mating, the mating portion 8 of the counterpart connector 200 is inserted into the mating space 40 of the shell 4 of the cable connector 100. At this point in time, the protruding portions 81 formed on the outer side surfaces of the mating portion 8 come into contact with inner side surfaces of the shell 4; therefore, the shell 4 deforms elastically in such a manner as to expand into an elliptic shape (refer to arrows A11). In this case, the first slit 45 that is formed in the shell 4 and extends along the circumferential direction promotes such deformation of the shell 4 into an elliptic shape. Moreover, when the mating portion 8 of the counterpart connector 200 is inserted into the mating space 40, the shell 4 deforms elastically in such a manner as to expand into an elliptic shape as described above, and also deforms elastically in such a manner as to expand in the left-and-right direction along the circumferential direction (or equivalently, expand into a Y shape) as indicated with arrows A12. In this case, the two second slits 46 that are formed in the shell 4 and extend backward from the two end portions of the first slit 45 promote such deformation of the shell 4 in the left-and-right direction along the circumferential direction. The shell 4 deforms as described above; therefore, the protruding portions 81 of the mating portion 8 of the counterpart connector 200 can be appropriately engaged (locked) in the through-holes 41 of the shell 4 of the cable connector 100.

Note that the illustrations are omitted in FIG. 9 for convenience of description, but the second slits 46 are provided also in the underside of the shell 4 (refer to FIG. 7). Hence, elastic deformation in the left-and-right direction along the circumferential direction occurs also on the underside of the shell 4.

Next, the unlocking of the cable connector 100 and the counterpart connector 200 is described with reference to FIG. 10. At the time of the unlocking, a user presses the shell 4 with his/her fingers in the up-and-down direction. Typically, a user presses a location of the third slit 47 of the shell 4 with his/her thumb or index finger (an arrow A21), and presses a location of the shell 4 on an opposite side to the third slit 47 with the other of the thumb or the index finger (an arrow A22). Consequently, the third slit 47 that extends along the axial direction in the shell 4 is displaced downward, and the gap of the third slit 47 widens. In other words, the shell 4 deforms elastically in such a manner as to expand in the left-and-right direction (refer to arrows A23). Also in this case, the two second slits 46 that are formed in the shell 4 and extend backward from the two end portions of the first slit 45 promote the deformation of the shell 4 in the left-and-right direction. Moreover, when being pressed in the up-and-down direction with the user's fingers, the shell 4 deforms elastically in such a manner as to expand in the left-and-right direction as described above (the arrows A23), and also deforms elastically in such a manner as to expand into an elliptic shape (arrows A24). The shell 4 deforms as described above; therefore, the engagement of the through-holes 41 of the shell 4 of the cable connector 100 and the protruding portions 81 of the mating portion 8 of the counterpart connector 200 is appropriately released (unlocked).

Note that in the embodiment, sufficient spaces 40a and 40b in FIG. 10 are secured in the mating space 40 formed by the shell 4 in such a manner as to appropriately allow the shell 4 to deform elastically as described above (refer to the arrows A11, A12, A23, and A24 of FIGS. 9 and 10). Specifically, the space 40a is a space between the top (corresponding to the bent portions 47a) of the shell 4 and the top of the mating portion 8 of the mated counterpart connector 200 as illustrated in FIG. 10. Moreover, the space 40b is a space between the bottom (a portion facing the bent portions 47a) of the shell 4 and the bottom of the mating portion 8 of the mated counterpart connector 200 as illustrated in FIG. 10.

From the above description, according to the embodiment, the first slits 45, the second slits 46, and the third slit 47, which are provided in the shell 4 of the cable connector 100, promote the elastic deformation of the shell 4 to enable appropriately locking and unlocking the counterpart connector 200. Specifically, according to the embodiment, the counterpart connector 200 can be securely locked and unlocked with a simple configuration. In addition, according to the embodiment, such locking and unlocking of the counterpart connector 200 can be performed with the shell 4 alone without using a separate sleeve from the shell as in the technology described in JP-A-2006-66354. Moreover, in the shell 4 according to the embodiment, the lock portion 4a, the housing holding portion 4b, and the cable holding portion 4c are integrally formed along the axial direction. As a result, according to the embodiment, the entire cable connector 100 can be effectively reduced in size.

Moreover, according to the embodiment, the shell 4 includes the pair of the first slits 45 and the pair of the two second slits 46. The pair of the first slits 45 is provided in such a manner as to face each other in the direction orthogonal to the axial direction, and the pair of the two second slits 46 is provided in such a manner as to face each other in the direction orthogonal to the axial direction. Hence, the counterpart connector 200 can be locked and unlocked more appropriately.

Moreover, according to the embodiment, the two second slits 46 of the shell 4 extend along the axial direction respectively from the two end portions of the first slit 45 in such a manner as to be orthogonal to the first slit 45. Hence, the counterpart connector 200 can be locked and unlocked more appropriately.

Moreover, according to the embodiment, the shell 4 is produced by curving the plate-shaped member of which portions (the bent portions 47a) at the two ends have been bent, in such a manner as to form an approximately cylindrical shape. The third slit 47 of the shell 4 is formed by the gap between the bent portions (the bent portions 47a) at the two ends of the plate-shaped member. Such use of the gap between the bent portions 47a as the third slit 47 enables preventing the user from feeling pain in the finger when the user performs the action of pressing the location of the third slit 47 to unlock the cable connector 100 and the counterpart connector 200.

Moreover, according to the embodiment, the shell 4 includes the pair of through-holes 41 that is provided in such a manner as to face each other in the direction orthogonal to the axial direction. In this case, the mating portion 8 of the counterpart connector 200 also includes the pair of protruding portions 81 that is provided in such a manner as to face each other in the direction orthogonal to the axial direction. Consequently, the shell 4 can lock the counterpart connector 200 securely.

Modification

Next, a modification of the above-mentioned embodiment is described. FIG. 11 is a perspective view of a shell of a cable connector according to the modification of the embodiment. Note that in FIG. 11, the same reference numerals are assigned to the same components as those of the shell 4 according to the above-mentioned embodiment, and descriptions thereof are omitted here.

In the above-mentioned embodiment, only one third slit 47 is provided to the shell 4. On the other hand, as illustrated in FIG. 11, a shell 4x of the cable connector according to the modification includes two third slits 50. Specifically, the shell 4x includes the pair of third slits 50 that is provided in such a manner as to face each other in the direction orthogonal to the axial direction. The third slits 50 according to the modification are formed wider than the third slit 47 of the embodiment, or equivalently, the third slits 50 according to the modification are longer in the circumferential direction than the third slit 47 of the embodiment. On the other hand, the third slits 50 according to the modification are not formed by the gap between the bent portions (the bent portions 47a) at the two ends of the plate-shaped member forming the shell 4, in contrast to the third slit 47 of the embodiment. Instead, the third slits 50 according to the modification are formed by, for example, punched portions in the plate-shaped member forming the shell 4x.

In this manner, the shell 4x according to the modification includes the pair of third slits 50 that is provided in such a manner as to face each other in the direction orthogonal to the axial direction, which also enables locking and unlocking the counterpart connector 200 more appropriately.

Note that the above-mentioned embodiment is provided for illustrative purposes to describe the technology of the present disclosure. The technology of the present disclosure is not limited to the embodiment. The technology of the present disclosure can be carried out in various forms without departing from a gist thereof.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A cable connector comprising:
a terminal that is connected to an electric wire in a cable;
a housing that holds the terminal; and
a shell having an approximately cylindrical shape, the shell being formed in such a manner as to cover the housing and to receive a counterpart connector that mates with the cable connector, wherein
the shell includes:
a lock portion having an engagement portion that, upon the cable connector being mated to the counterpart connector, is engaged with a protruding portion or a recessed portion formed on an outer side surface of the counterpart connector and locks the counterpart connector;
a housing holding portion that holds the housing; and
a cable holding portion that holds the cable,
the lock portion, the housing holding portion, and the cable holding portion of the shell are integrally formed along an axial direction of the shell, and
the shell further includes:
a first slit formed on a second side opposite in the axial direction to a first side that mates with the counterpart connector relative to the engagement portion of the lock portion, the first slit extending along a circumferential direction of the shell;
two second slits extending respectively from two end portions of the first slit toward the second side; and
a third slit extending along the axial direction from an end portion on the first side of the shell to the first slit.

2. The cable connector according to claim 1, wherein
the shell includes a pair of the first slits and a pair of the two second slits, and
the pair of the first slits is provided in such a manner as to face each other in a direction orthogonal to the axial direction, and the pair of the two second slits is provided in such a manner as to face each other in the direction orthogonal to the axial direction.

3. The cable connector according to claim 2, wherein the shell includes a pair of the third slits that is provided in such a manner as to face each other in the direction orthogonal to the axial direction.

4. The cable connector according to claim 1, wherein the two second slits of the shell extend along the axial direction respectively from the two end portions of the first slit in such a manner as to be orthogonal to the first slit.

5. The cable connector according to claim 1, wherein
the shell is produced by curving a plate-shaped member of which portions at two ends have been bent, in such a manner as to form an approximately cylindrical shape, and
the third slit of the shell is formed by a gap between the bent portions at the two ends of the plate-shaped member.

6. The cable connector according to claim 1, wherein the shell includes a pair of the engagement portions that is provided in such a manner as to face each other in a direction orthogonal to the axial direction.

7. The cable connector according to claim 1, wherein the shell is made of metal.
